(19) United States
(12) Patent Application Publication
(10) Pub. No.: US 2008/0224030 A1
(43) Pub. Date: Sep. 18, 2008

(54) NON-CONTACT THERMAL IMAGING SYSTEM FOR HETEROGENEOUS COMPONENTS

(75) Inventors: Julien Sylvestre, Chambly (CA); Luc Tousignant, Chambly (CA)

Correspondence Address: CANTOR COLBURN LLP - IBM FISHKILL, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/685,371

(22) Filed: Mar. 13, 2007

(51) Int. Cl. G01J 5/52

(52) U.S. Cl. 250/252.1; 250/350

(57) ABSTRACT

A non-contact thermal imaging system for heterogeneous materials, the system including a translating head that is parallel to a reference plane; an infrared probe connected to data acquisition electronics in order to collect first data, the first data being nitrated intensity readings; a transmitter for sending one or more signals to a sample; and a receiver for receiving the one or more signals from the sample; wherein the transmitter and the receiver measure an intensity of the one or more signals reflected off the sample as second data; and wherein the first data and the second data are combined via software to calculate a temperature at every point on the sample.

### TRADEMARKS

IBM® is a registered trademark of International Business Machines Corporation, Armonk, N.Y., U.S.A. Other names used herein maybe registered trademarks, trademarks or product names of International Business Machines Corporation or other companies.

### BACKGROUND OF THE INVENTION

1. Field of the Invention

This invention relates to thermal imaging systems, and particularly to a non-contact thermal imaging system for heterogeneous components.

2. Description of Background

In the microelectronics industry, and in other industries, there is an ever-increasing need for instruments that can inspect and characterize devices and structures at various stages during their processing and manufacture. In particular, there is a need for non-destructive detection of both surface and sub-surface features, particularly in devices, which are essentially multilayer structures. One technique, which is important as a non-destructive testing and characterization tool, is thermal wave imaging.

Thermal wave imaging has many applications in semiconductors and in other industries. This non-destructive inspection tool can be used to image sub-surface defects in silicone in integrated circuits. It can also be used as a characterization tool in the study and the optimization of solutions to manage large heat production in high power packages.

Existing thermal wave imaging technologies include infrared cameras, which are generally unable to deal with multiple materials over a wide spectral band, and two-color infrared probes, which are expensive and/or accurate only for high temperature measurements.

Considering the above limitations, it is desired to have a non-contact thermal imaging system with good spectral response over a wide temperature range for heterogeneous components.

### SUMMARY OF THE INVENTION

The shortcomings of the prior art are overcome and additional advantages are provided through the provision of a system comprising: a translating head that is parallel to a reference plane; a probe connected to data acquisition electronics in order to collect first data, the first data being proportional to temperature, with a proportionality constant that depends on the emissivity of the sample; a transmitter for sending one or more signals to a sample; and a receiver for receiving the one or more signals from the sample; wherein the transmitter and die receiver measure an intensity of the one or more signals reflected off the sample as second data; and wherein the first data and the second data are combined via software to calculate a temperature at every point on the sample.

Additional features and advantages are realised through the techniques of the present invention. Other embodiments and aspects of the invention are described in detail herein and are considered a part of the claimed invention. For a better understanding of the invention with advantages and features, refer to the description and the drawings.

### TECHNICAL EFFECTS

As a result of the summarized invention, technically we have achieved a solution for a non-contact thermal imaging system for heterogeneous components.

### BRIEF DESCRIPTION OF THE DRAWINGS

The subject matter, which is regarded as the invention, is particularly pointed oat and distinctly claimed in the claims at the conclusion of the specification. The foregoing and other objects, features, and advantages of the invention are apparent from the following detailed description taken in conjunction with the accompanying drawings in which:

FIG. 1 is a schematic diagram of a non-contact thermal imaging system, in accordance with an embodiment of the invention;

FIG. 2 is a schematic diagram of FIG. 1 including an emissivity subsystem, in accordance with an embodiment of the invention;

FIG. 3 is a schematic diagram illustrating exemplary curves of probe voltage versus true temperature measurements, for different values of voltage measured by the emissivity sub-system (which are proportional to the surface emissivity), in accordance with an embodiment of the invention.

### DETAILED DESCRIPTION OF THE INVENTION

One aspect of the exemplary embodiments is a non-contact thermal imaging system for heterogeneous components made from materials of widely varying emissivities (e.g., plastic and silicium). Another aspect of the exemplary embodiments is an electronic chip packaging, assembling and testing environment that provides accurate infrared temperature imaging of heterogeneous components comprised of various materials and making use of a probe calibrated using materials of different emissivities.

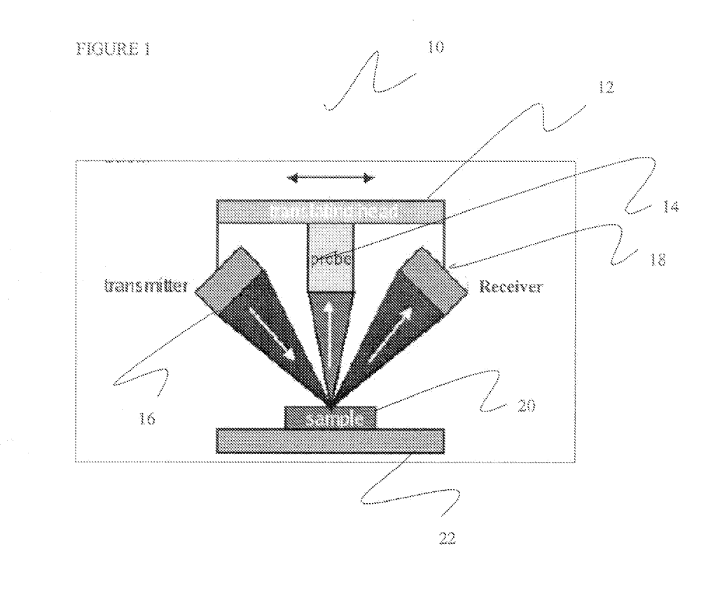

Referring to FIG. 1, a schematic diagram of a non-contact thermal imaging system, in accordance with an embodiment of the invention is illustrated. The non-contact thermal imaging system 10 includes a translating head 12, an infrared probe 14, a transmitter 16, a receiver 18, a sample 20, and a reference plane 22.

In an exemplary embodiment, a translating head 12 moves parallel to a reference plane 22 located above a sample 20 to he imaged. The translating bead 12 supports a broadband infrared detector or probe 14, which is connected to data acquisition electronics (not shown). The translating head 12 also supports an infrared transmitter 16 and an infrared receiver 18, connected to data acquisition electronics, which can send a modulated signal on a point of the sample 20 and measure the intensity of the reflected signal, thus measuring the emissivity of the surface, in the proper wavelength domain, at that point. The infrared probe 14 and emissivity measurements are combined in software to calculate precisely the actual temperature of every point on the sample 20 being imaged.

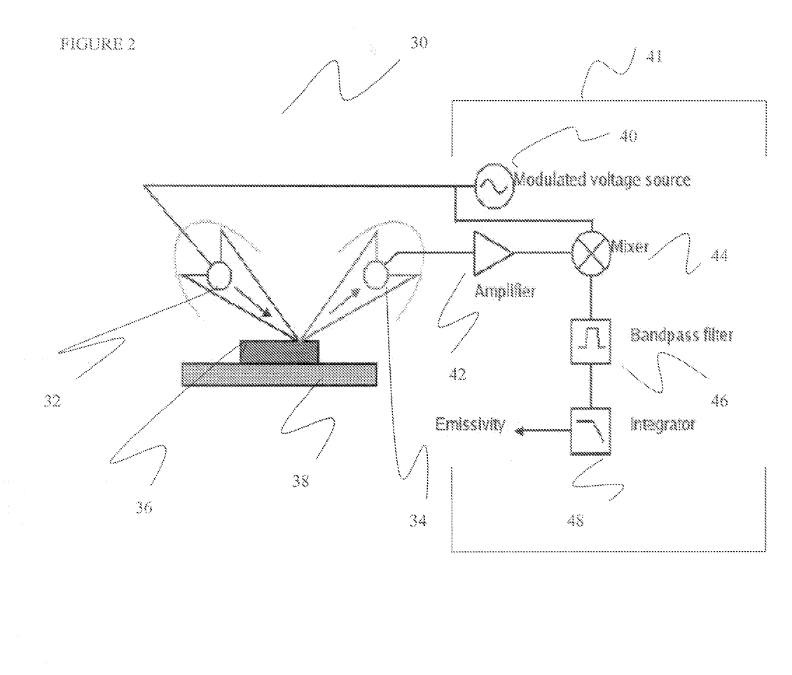

Referring to FIG. 2, a schematic diagram of FIG. 1 including an emissivity sub-system, in accordance with an embodiment of the invention is illustrated. The system 30 includes a transmitter 32, a receiver 34, a sample 36, a reference plane 38, a modulated voltage source 40, an amplifier 42, a mixer 44, a bandpass filter 46, and an integrator 48. Elements 40. 42, 44, 46, and 48 constitute the emissivity subsystem 41.

The emissivity subsystem 41 modulates its infrared signal in order to reduce the influence of noise. The defected signal is demodulated using a filter 46 matched to the source modulation 40, in a scheme that maximizes the signal-to-noise ratio at the receiver end 34 for low emissivity measurements. The infrared source is collimated using an elliptic reflector to restrict the measurement region to a very small area.

If the infrared probe 14 of FIG. 1 were used without the emissivity subsystem 41, two materials at the same temperature but with emissivities at the two ends of the spectrum (e.g., plastic and polished aluminum) would appear to be a very different temperature. The probe 14 is calibrated using standards made of materials of different emissivities, which are molded in small samples with an embedded thermocouple. By heating these standards to different temperatures, calibration curves of probe voltage versus the true temperature are generated for different emissivities.

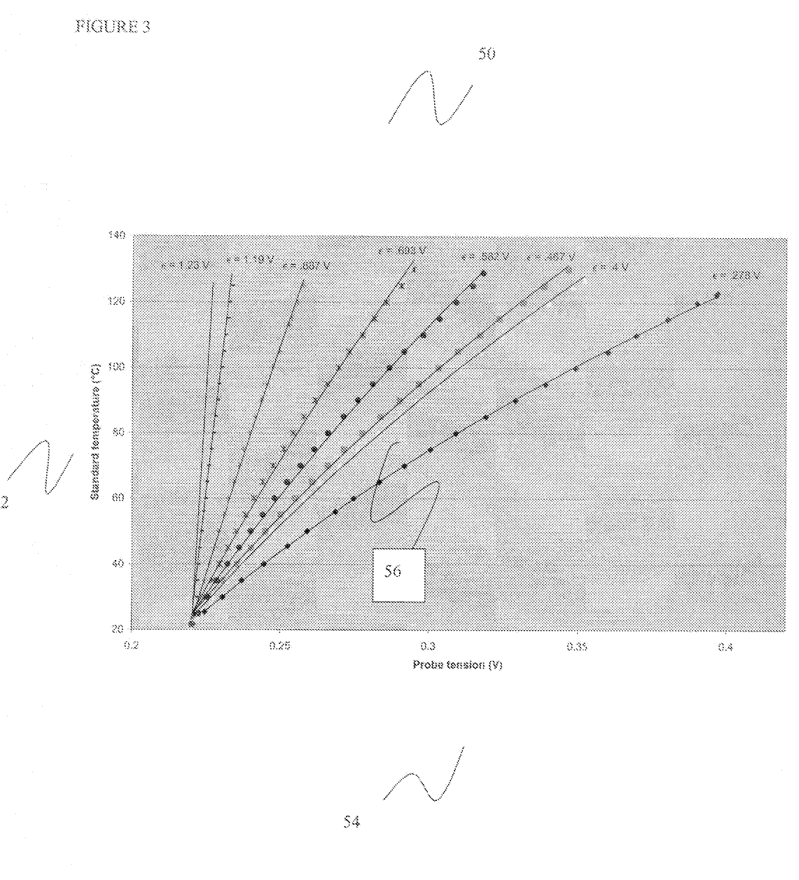

Referring to FIG. 3, a schematic diagram illustrating exemplary curves of probe voltage versus true temperature measurements is depicted. The diagram 50 includes a plurality of curves 56. Every one of the plurality of curves correspond to a different material with a particular emissivity. Every curve is labeled by the voltage measured by the emissivity sub-system for a particular material. The y-axis represents temperature of the measured material 52 and the x-axis represents probe voltage variations 54. Using a probe voltage and emissivity voltage from a point on the sample 20 being measured, as shown in FIG. 1, linear interpolation is used to determine the true temperature.

Therefore, the exemplary embodiments described provide for a non-contact thermal imaging system for heterogeneous components by having emissivity measurements combined in software to calculate precisely the actual temperature of every point on a sample substrate. The sample to be imaged is scanned by the apparatus, which measures simultaneously infrared emissions and the sample's emissivity at every point. The system can handle any material without prior knowledge of its emission properties and it is low-cost.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a pan of a computer system or sold separately.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A non-contact thermal imaging system for heterogeneous materials, the system comprising:
a translating head that is parallel to a reference plane;
a probe connected to data acquisition electronics in order to collect first data, the first data being unrated intensity readings;
a transmitter configured to send one or more signals to a sample; and
a receiver configured to receive the one or more signals from the sample;
wherein the transmitter and the receiver measure an intensity of the one or more signals reflected off the sample as second data; and
wherein the first data and the second data are combined via software to calculate a temperature at every point on the sample.

2. The system of claim 1, wherein the heterogeneous material is plastic.

3. The system of claim 1, wherein the heterogeneous material is silicium.

4. The system of claim 1, wherein the probe is calibrated by using standards made of materials of different emissivities.

5. A non-contact thermal imaging method for using heterogeneous materials, the method comprising:
providing a translating head that is parallel to a reference plane;
providing a probe connected to data acquisition electronics in order to collect first data, the first data being infrared intensity readings;
providing a transmitter configured to send one or more signals to a sample; and
providing a receiver configured to receive the one or more Signals from the sample;
wherein the transmitter and the receiver measure an intensity of the one or more signals reflected off lire sample as second data; and
wherein the first data and the second data are combined via software to calculate a temperature at every point on the sample.

6. The method of claim 5, wherein the heterogeneous material is plastic.

7. The method of claim 5, wherein the heterogeneous material is silicium.

8. The method of claim 5, wherein the probe is calibrated by using standards made of materials of different emissivities.
